(19) United States
(12) Patent Application Publication
(10) Pub. No.: US 2019/0218113 A1
(43) Pub. Date: Jul. 18, 2019

(54) FLOW THROUGH TYPE ULTRAVIOLET LED DISINFECTING APPARATUS

(71) Applicant: Hangzhou Wisens Technology Co., Ltd., Hangzhou (CN)

(72) Inventors: Nan MENG, Hangzhou (CN); Deheng ZHANG, Hangzhou (CN); Lifei TONG, Hangzhou (CN); Zhaoliang JIANG, Hangzhou (CN); Xiangwen LIU, Hangzhou (CN); Chengfeng LI, Hangzhou (CN); Zhichao ZHU, Hangzhou (CN)

(73) Assignee: Hangzhou Wisens Technology Co., Ltd., Hangzhou (CN)

(21) Appl. No.: 16/166,132

(22) Filed: Oct. 21, 2018

(30) Foreign Application Priority Data
Jan. 18, 2018 (CN) 201820086985.8

(51) Int. Cl. C02F 1/32

(52) U.S. Cl. CPC C02F 1/325

(57) ABSTRACT

This invention provides a flow through type ultraviolet LED disinfecting apparatus, and a top cover and an outer cylindrical body are connected by a thread; a transparent inner cup body has a water holding tank inside for containing water, and there is a water pipe at the top of cover; a depth of the inlet water pipe reaching into the water holding tank has greater efficient than tank without pipe; a pipe mouth at one end of the inlet water pipe reaching into the water holding tank corresponds to a LED disinfecting light; the outer cylindrical body is tube-shaped, a side wall body and a bottom plate; the side wall body is sleeved outside the transparent inner cup body; a bottom of the transparent inner cup body contacts with the bottom plate of the inner cylindrical body; he circuit board with LED disinfecting LED is fixed at the bottom plate.

### CROSS REFERENCE TO RELATED APPLICATIONS

This application claims priority to CN 201820086985.8 filed Jan. 18, 2018, which is incorporated herein by reference.

### BACKGROUND OF THE INVENTION

### Field of the Invention

This invention relates to a flow through type ultraviolet LED disinfecting apparatus.

### Description of the Related Art

The flow through type ultraviolet LED disinfecting apparatus usually uses a metallic housing, a water inlet and a water outlet are directly integrated, the time of water flow passing through the device is short, and utilization rate of LED radiation is not high.

A waterway design of the conventional flow through type ultraviolet LED disinfecting apparatus is unreasonable, and the utilization rate of the LED radiation is low; and water in the device has blind areas (places where the LED cannot be irradiated), resulting in an unstable disinfecting effect and high material cost, which is not conducive to reducing the cost.

### BRIEF SUMMARY OF THE INVENTION

In order to solve deficiencies of the prior art, this invention aims to provide a novel flow through type ultraviolet LED disinfecting module structure, which has advantages of new waterway design, high utilization rate of LED radiation, less blind areas, compact structure, convenient installation, and low cost.

In order to achieve the above-mentioned objectives, this invention adopts the following technical solution:

A flow through type ultraviolet LED disinfecting apparatus includes: a top cover, a transparent inner cup body, an outer cylindrical body, a LED disinfecting light, and a circuit board; the top cover being fixed with or having an inlet water pipe and an outlet water pipe; the top cover and the outer cylindrical body being connected by a thread; the transparent inner cup body having a water holding tank inside for containing water; the water entering the water holding tank from the inlet water pipe and being discharged from the outlet water pipe; a top of the transparent inner cup body having a tank mouth of the water holding tank; a depth of the inlet water pipe reaching into the water holding tank being greater than a depth of the outlet water pipe reaching into the water holding tank; a pipe mouth at one end of the inlet water pipe reaching into the water holding tank corresponding to the LED disinfecting light; a pipe mouth at one end of the outlet water pipe near the transparent inner cup body deviating the LED disinfecting light; the outer cylindrical body being tube-shaped and including: a side wall body and a bottom plate; the side wall body being sleeved outside the transparent inner cup body; a bottom of the transparent inner cup body contacting with the bottom plate of the outer cylindrical body; the LED disinfecting light being fixed at the circuit board; and the circuit board being fixed at the bottom plate.

Further, pipe mouths at two ends of the inlet water pipe may be an inlet water pipe inlet of the inlet water pipe for water to enter in and an inlet water pipe outlet of the inlet water pipe for water to be discharged out, respectively; pipe mouths at two ends of the outlet water pipe may be an outlet water pipe inlet of the outlet water pipe for water to enter in and an outlet water pipe outlet of the outlet water pipe for the water to be discharged out, respectively; the inlet water pipe outlet may be located at one side of the top cover near the transparent inner cup body and may reach deep into the water holding tank; and the inlet water pipe inlet and the outlet water pipe outlet may be located at one side of the top cover away from the transparent inner cup body.

Further, the inlet water pipe outlet may correspond to the LED disinfecting light; and the outlet water pipe inlet may deviate the LED disinfecting light.

Further, a middle of the bottom plate may have a through hole. Further, light emitted by the LED disinfecting light may pass through the through hole and be irradiated into the water holding tank.

Further, the flow through type ultraviolet LED disinfecting apparatus may further include a waterproof sealing cushion ring; and the waterproof sealing cushion ring may be located inside the top cover. Further, the waterproof sealing cushion ring may be made of a silicone material.

Further, an inner wall of the side wall body may be an annular surface; and an outer wall of the side wall body may have an external thread.

Further, the transparent inner cup body may be made of a quartz material. Further, the outer cylindrical body may be made of a plastic material.

Further, the inlet water pipe may have a first inlet water pipe and a second inlet water pipe; the first inlet water pipe may be formed by the top cover; and the second inlet water pipe may be connected with the first inlet water pipe.

Advantages of this invention are: radiation utilization rate being high, blind areas are less, the structure is compact, the installation is convenient, the cost is low, and disinfecting efficiency is improved.

### BRIEF DESCRIPTION OF THE DRAWINGS

FIG. 1 is a schematic diagram of a flow through type ultraviolet LED disinfecting apparatus;

FIG. 2 is a sectional view of the flow through type ultraviolet LED disinfecting apparatus in FIG. 1;

FIG. 3 is an exploded view of the flow through type ultraviolet LED disinfecting apparatus in FIG. 1; and

FIG. 4 is a partial enlarged view of the flow through type ultraviolet LED disinfecting apparatus in FIG. 2.

flow through type ultraviolet LED disinfecting apparatus, 100; inlet water pipe, 101; first inlet water pipe, 101a; second inlet water pipe, 101b; outlet water pipe, 102; top cover, 103; transparent inner cup body, 104; outer cylindrical body, 105; LED disinfecting light, 106; circuit board, 107; water holding tank, 108; side wall body, 109; bottom plate, 110; through hole, 111; and waterproof sealing cushion ring, 112.

### DETAILED DESCRIPTION OF THE INVENTION

This invention will be specifically described below in combination with the drawings and specific embodiments.

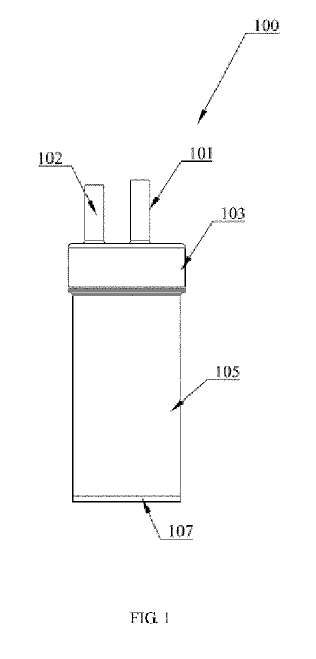

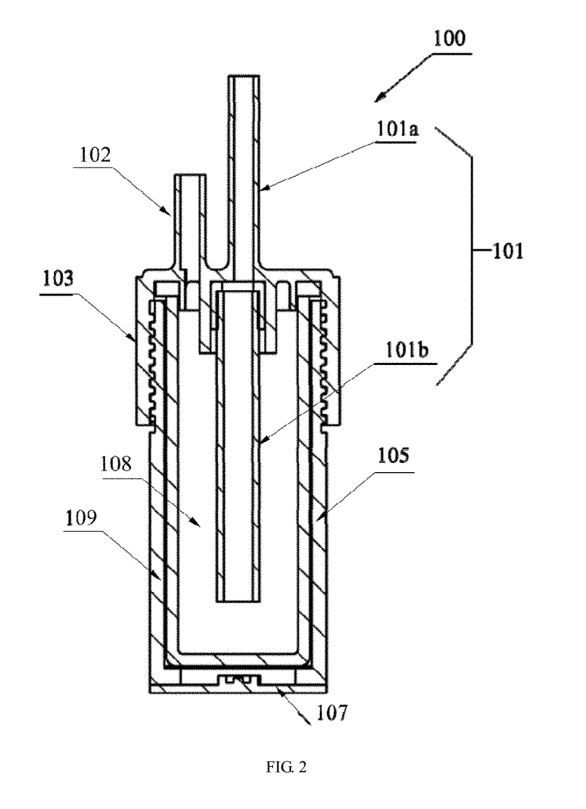

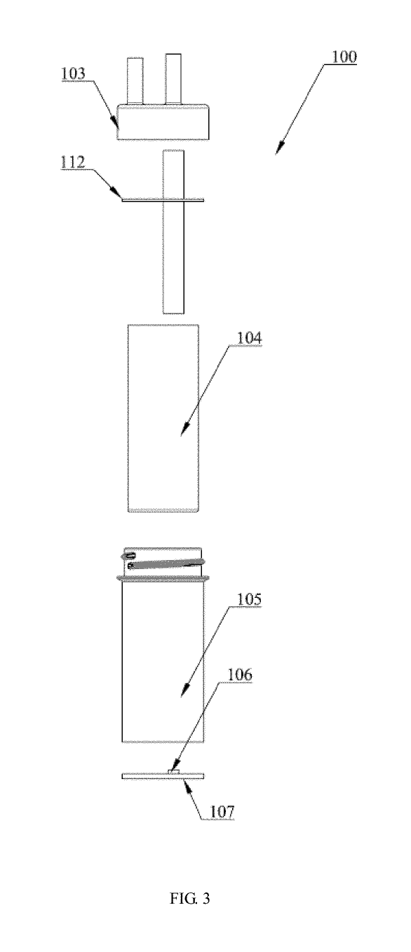

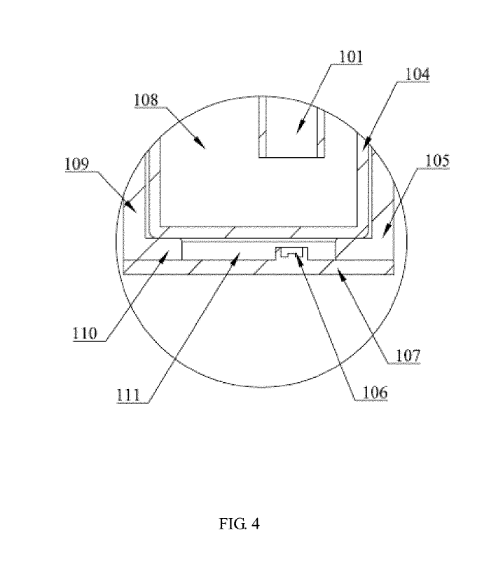

As shown in FIG. 1 to FIG. 4, a flow through type ultraviolet LED disinfecting apparatus 100, includes: a top cover 103, a transparent inner cup body 104, an outer cylindrical body 105, a LED disinfecting light 106, and a circuit board 107; the top cover 103 being fixed with or having an inlet water pipe 101 and an outlet water pipe 102; the top cover 103 and the outer cylindrical body 105 being connected by a thread; the transparent inner cup body 104 having a water holding tank 108 inside for containing water; the water entering the water holding tank 108 from the inlet water pipe 101 and being discharged from the outlet water pipe 102; a top of the transparent inner cup body 104 having a tank mouth of the water holding tank 108; a depth of the inlet water pipe 101 reaching into the water holding tank 108 being greater than a depth of the outlet water pipe 102 reaching into the water holding tank 108; a pipe mouth at one end of the inlet water pipe 101 reaching into the water holding tank 108 corresponding to the LED disinfecting light 106; a pipe mouth at one end of the outlet water pipe 102 near the transparent inner cup body 104 deviating the LED disinfecting light 106; the outer cylindrical body 105 being tube-shaped and including: a side wall body 109 and a bottom plate 110; the side wall body 109 being sleeved outside the transparent inner cup body 104; a bottom of the transparent inner cup body 104 contacting with the bottom plate 110 of the outer cylindrical body 105; the LED disinfecting light 106 being fixed at the circuit board 107; and the circuit board 107 being fixed at the bottom plate 110.

As a preferred implementation way, pipe mouths at two ends of the inlet water pipe 101 are an inlet water pipe inlet of the inlet water pipe 101 for water to enter in and an inlet water pipe outlet of the inlet water pipe 101 for water to be discharged out, respectively; pipe mouths at two ends of the outlet water pipe 102 are an outlet water pipe inlet of the outlet water pipe 102 for water to enter in and an outlet water pipe outlet of the outlet water pipe 102 for the water to be discharged out, respectively; the inlet water pipe outlet is located at one side of the top cover 103 near the transparent inner cup body 104 and reaches deep into the water holding tank 108; and the inlet water pipe inlet and the outlet water pipe outlet are located at one side of the top cover 103 away from the transparent inner cup body 104.

As a preferred implementation way, the inlet water pipe outlet corresponds to the LED disinfecting light 106; and the outlet water pipe inlet deviates the LED disinfecting light 106.

As a preferred implementation way, a middle of the bottom plate 110 has a through hole 111.

As a preferred implementation way, light emitted by the LED disinfecting light 106 passes through the through hole 111 and is irradiated into the water holding tank 108.

As a preferred implementation way, the flow through type ultraviolet LED disinfecting apparatus 100 further includes a waterproof sealing cushion ring 112; and the waterproof sealing cushion ring 112 is located inside the top cover 103.

As a preferred implementation way, the waterproof sealing cushion ring 112 is made of a silicone material.

As a preferred implementation way, an inner wall of the side wall body 109 is an annular surface; and an outer wall of the side wall body 109 has an external thread.

As a preferred implementation way, the transparent inner cup body 104 is made of a quartz material. As a preferred implementation way, the outer cylindrical body 105 is made of a plastic material.

As a preferred implementation way, the inlet water pipe 101 has a first inlet water pipe 101a and a second inlet water pipe 101b; the first inlet water pipe 101a is formed by the top cover 103; and the second inlet water pipe 101b is connected with the first inlet water pipe 101a.

The pipe mouth at one end of the inlet water pipe 101 reaching into the water holding tank 108 corresponds to the LED disinfecting light 106. Residence time of water flow in the pipes is prolonged, and the water in the whole device presents a moving state through an eddy current way to reduce the blind areas.

The basic principle, main features and advantages of this invention are shown and described above. Those skilled in the art should understand that the above-mentioned embodiments do not limit this invention in any form, and any technical solutions obtained by means of equivalent replacement or equivalent transformation is within the protection scope of this invention.

What is claimed is:

1. A flow through type ultraviolet LED disinfecting apparatus, comprising:
a top cover, a transparent inner cup body, an outer cylindrical body, a LED disinfecting light, and a circuit board; wherein the top cover is fixed with or has an inlet water pipe and an outlet water pipe; the top cover and the outer cylindrical body are connected by a thread; the transparent inner cup body has a water holding tank inside for containing water; the water enters the water holding tank from the inlet water pipe and is discharged from the outlet water pipe; a top of the transparent inner cup body has a tank mouth of the water holding tank; a depth of the inlet water pipe reaching into the water holding tank is greater than a depth of the outlet water pipe reaching into the water holding tank; a pipe mouth at one end of the inlet water pipe reaching into the water holding tank corresponds to the LED disinfecting light; a pipe mouth at one end of the outlet water pipe near the transparent inner cup body deviates the LED disinfecting light; the outer cylindrical body is tube-shaped and comprises: a side wall body and a bottom plate; the side wall body is sleeved outside of the transparent inner cup body; a bottom of the transparent inner cup body contacts with the bottom plate of the outer cylindrical body; the LED disinfecting light is fixed at the circuit board; and the circuit board is fixed at the bottom plate.

2. The flow through type ultraviolet LED disinfecting apparatus according to claim 1, wherein pipe mouths at two ends of the inlet water pipe are an inlet water pipe inlet of the inlet water pipe for water to enter in and an inlet water pipe outlet of the inlet water pipe for water to be discharged out, respectively; pipe mouths at two ends of the outlet water pipe are an outlet water pipe inlet of the outlet water pipe for water to enter in and an outlet water pipe outlet of the outlet water pipe for the water to be discharged out, respectively; the inlet water pipe outlet is located at one side of the top cover near the transparent inner cup body and reaches deep into the water holding tank; and the inlet water pipe inlet and the outlet water pipe outlet are located at one side of the top cover away from the transparent inner cup body.

3. The flow through type ultraviolet LED disinfecting apparatus according to claim 2, wherein the inlet water pipe outlet corresponds to the LED disinfecting light; and the outlet water pipe inlet deviates the LED disinfecting light.

4. The flow through type ultraviolet LED disinfecting apparatus according to claim 1, wherein a middle of the bottom plate has a through hole.

5. The flow through type ultraviolet LED disinfecting apparatus according to claim 4, wherein light emitted by the LED disinfecting light passes through the through hole and is irradiated into the water holding tank.

6. The flow through type ultraviolet LED disinfecting apparatus according to claim 1, wherein the flow through type ultraviolet LED disinfecting apparatus further comprises a waterproof sealing cushion ring; and the waterproof sealing cushion ring is located inside the top cover.

7. The flow through type ultraviolet LED disinfecting apparatus according to claim 6, wherein the waterproof sealing cushion ring is made of a silicone material.

8. The flow through type ultraviolet LED disinfecting apparatus according to claim 1, wherein an inner wall of the side wall body is an annular surface; and an outer wall of the side wall body has an external thread.

9. The flow through type ultraviolet LED disinfecting apparatus according to claim 1, wherein the transparent inner cup body is made of a quartz material; and the outer cylindrical body is made of a plastic material.

10. The flow through type ultraviolet LED disinfecting apparatus according to claim 1, wherein the inlet water pipe has a first inlet water pipe and a second inlet water pipe; the first inlet water pipe is formed by the top cover; and the second inlet water pipe is connected with the first inlet water pipe.
